(19) United States
(12) Patent Application Publication
(10) Pub. No.: US 2003/0211945 A1
(43) Pub. Date: Nov. 13, 2003

(54) Natural herbicide compositions

(76) Inventor: James L. Lewis, Ontario (CA)

Correspondence Address: Schwegman, Lundberg, Woessner & Kluth, P.A., P.O. Box 2938, Minneapolis, MN, 55402, US

(21) Appl. No.: 10/435,990

(22) Filed: May 12, 2003

Related U.S. Application Data
(60) Provisional application No. 60/380,510, filed on May 13, 2002.
(60) Provisional application No. 60/434,858, filed on Dec. 19, 2002.

(51) Int. Cl. A01N 25/26; A01N 37/00; A01N 47/28

(52) U.S. Cl. 504/320; 504/327; 504/142

(57) ABSTRACT

The invention can be summarized as follows. There is provided a natural herbicide composition comprising urea, water, acetic acid and optionally a binding agent. The natural herbicide may also comprise one or more salts and citric acid cycle intermediates. Also disclosed are methods of treating weeds or plots of land that have weeds, as well as methods of making the natural herbicide composition.

The present invention relates to herbicide compositions. More specifically the present invention relates to natural herbicide compositions.

### BACKGROUND OF THE INVENTION

The use of herbicides to control weeds and kill pests is commonplace. Collectively, several million pounds of herbicides is applied directly to soil and plants in an effort to prevent weed growth. Due to the large market for herbicides, there has been substantial research in the development of herbicides.

Herbicides may be classified as either selective or non-selective herbicides, depending on whether the herbicide selectively inhibits or kills vegetation. In this regard, a non-selective herbicide inhibits the growth or kills all vegetation it contacts. An example of a non-selective herbicide is N-(phosphonomethyl)glycine or “Roundup®”. In contrast, a selective herbicide inhibits the growth or kills only specific vegetation, but may have little or no effect on other types of vegetation. A well know example of a non-selective herbicide is 2,4-dichlorophenoxyacetic acid (2,4-D) which is known to selectively kill broad leafed weeds such as turf grass. However, other types of vegetation are known to be resistant to this herbicide.

A major drawback of many of the herbicides currently used is that they are toxic to the environment, humans or animals that contact them. For example, 2-4D may cause eye irritation and gastointestinal problems if ingested in sufficient quantities by animals or humans. This creates a major concern when contemplating the use of herbicides on vegetation that is to be consumed by humans or animals, or when applying herbicides to areas such as lawn or golf courses that are actively used by humans or other animals.

Recently, due to environmental considerations, many herbicides have been criticized as being chemical pollutants and it has been argued that their negative impact on the environment far outweighs any advantages that may be realized by their use. Further, with many municipalities and towns banning or limiting synthetic pesticides, herbicides and fertilizers, the general public, municipalities, government public works departments and utilities are actively looking for effective replacement products in order to control weeds and pests and keep their properties neat-looking and attractive.

Therefore, there is a need in the art for natural herbicides comprising elements that are not toxic to the environment or a safety concern to humans or animals. Further, there is a need in the art for a natural herbicide made from food and feed grade ingredients which lack harmful chemicals, heavy metals, animal products, recycled or waste materials, or pathogens.

Natural herbicides are known in the art. For example U.S. Pat. Re. 34,494 (of U.S. Pat. No. 5,030,268) discloses the addition of corn gluten meal to soil plots to achieve pre-emergence weed control. The patent teaches that corn gluten meal may be used as a substitute for chemical herbicides or as a supplement to chemical herbicides to reduce their concentration in the environment.

U.S. Pat. No. 6,323,153 discloses a method for selectively controlling undesirable vegetation by contacting the leaves with a herbicidal composition comprising a carboxylic or phosphonic acid salt known to form a coordination compound with calcium or magnesium salts.

U.S. Pat. No. 5,998,335 discloses a herbicidal composition comprising pine oil and either tea tree oil or eucalyptus oil. A drawback of the herbicide is that it is non-selective since the herbicide is effective against almost any vegetation, suggesting that its use to inhibit specific weed growth amongst good or valuable types of vegetation may be limited.

U.S. Pat. No. 5,074,901 discloses a liquor of sea water that may be used as a herbicide. The liquor may be applied directly to the root or leaf system of the plant to be killed. While the patent suggests applying the liquor directly to weeds such as dandelions, there is no suggestion as to whether the liquor may be applied as a selective herbicide to control at least one species of weeds among other types of vegetation.

U.S. Pat. No. 4,626,271 discloses an herbicidal composition comprising cyanobacterin and a surfactant. The composition is an effective herbicide for both monocotyledonous and dicotyledonous angiosperms. However, the patent does not disclose selective growth inhibition of specific weeds while leaving other plants such as grasses unperturbed. Further, the cyanobacterin is not readily available in mass quantities and must be isolated and prepared from biological organisms. Thus, these herbicidal compositions may be difficult and expensive to produce.

High concentrations of acetic acid have been reported to control selected weeds (IPM Practitioner, XXIV (8/9) August/September 2002). Concentrations of acetic acid below about 5% produced variable results for weed control, and in some cases re-growth from the roots was observed. Further, broadcast applications of high concentrations of acetic acid is expensive

There is a need in the art for novel natural herbicides. Further there is a need in the art for selective natural herbicides that are effective on weeds while posing little or no toxicity threat to the environment, humans or other animals. Further there is a need in the art for natural herbicides that are inexpensive to produce and easy to use.

It is an object of the present invention to overcome disadvantages of the prior art.

The above object is met by a combination of the features of the main claims. The sub claims disclose further advantageous embodiments of the invention.

### SUMMARY OF THE INVENTION

The present invention relates to herbicide compositions. More specifically the present invention relates to natural herbicide compositions

According to the present invention, there is provided a natural herbicide composition comprising urea, water and one, or more than one, of acetic acid, propylene glycol, seed oil or a mixture thereof, with the proviso that either acetic acid or propylene glycol, but not both, is present in the mixture. Urea may be present in an amount between about 30% (w/v) to about 62% (w/v), propylene glycol may be present in an amount between about 0% v/v and 30% v/v, and seed oil may be present in an amount between about 0% v/v and 30% v/v.

The present invention contemplates seed oil including, flax seed oil, canola oil, soybean oil, sunflower oil, peanut oil, cottonseed oil, corn oil, denaturalized flax seed oil, denaturalized canola oil, denaturalized soybean oil, denaturalized sunflower oil, denaturalized peanut oil, denaturalized cottonseed oil, denaturalized corn oil and mixtures thereof. Acetic acid may be provided as a concentrated solution or as vinegar, which typically contains 2% v/v to 20% v/v acetic acid.

Also contemplated by the present invention is a natural herbicide composition wherein urea is present in an amount between about 50% (w/v) and about 62% (w/v). A natural herbicide composition further comprising acetic acid in an amount between about 0.01% (v/v) and about 20% (v/v) is also considered by the present invention.

Further, according to the present invention, the natural herbicide composition may comprise urea in an amount of about 60% (w/v) and acetic acid in an amount of about 0.14% (v/v).

Also according to the present invention, there is provided a natural herbicide composition comprising

a) about 3 to about 6 parts by volume solid urea;

b) about 3 to about 5 parts by volume water, and;

c) one, or more than one, component selected from the group consisting of:

i) about 0.01 to about 5 parts by volume 100% v/v acetic acid;

ii) about 0.25 to about 5 parts by volume propylene glycol;

iii) about 0.25 to about 5 parts by volume seed oil; and

iv) a mixture thereof,

with the proviso that either acetic acid or propylene glycol, but not both, is present in the mixture and wherein the final concentration of urea in the composition is at least 30% w/v.

The present invention also contemplates a natural herbicide composition prepared by combining

a) about 3 to about 6 parts by volume solid urea;

b) about 3 to about 4 parts by volume water, and;

c) one, or more than one, component selected from the group consisting of:

i) about 0.01 to about 5 parts by volume 100% v/v acetic acid;

ii) about 0.25 to about 5 parts by volume propylene glycol;

iii) about 0.25 to about 5 parts by volume seed oil;

iv) and a mixture thereof,

with the proviso that either acetic acid or propylene glycol, but not both, is present in the mixture and wherein the final concentration of urea in the composition is at least 30% w/v.

The present invention, also pertains to a natural herbicide composition comprising,

a) about 5 parts by volume of urea;

b) about 4 parts by volume water, and;

c) about 0.0125 parts by volume 100% v/v acetic acid.

The present invention also contemplates a natural herbicide composition comprising about 8.5 parts by volume 50% w/v aqueous urea solution, and about 1.5 parts by volume propylene glycol.

The present invention further contemplates the natural herbicide composition as defined above and further comprising one, or more than one, component selected from the group consisting of salts, citric acid cycle intermediates, and pyruvate. The salts may comprise sea salts, sodium chloride, potassium chloride, calcium chloride, or a combination thereof. For example, the salts comprise sea salts or sodium chloride. Similarly, the citric acid cycle intermediate may be selected from the group consisting of citrate, cis-aconitate, isocitrate, α-ketoglutarate, succinate, fumarate, malate, or combinations thereof. For example, the citric acid cycle intermediate is citrate.

Further, the present invention provides a natural herbicide composition as defined above, wherein urea is present in an amount between about 30% w/v and about 62% w/v, salt is present in an amount of between about 0% w/v and about 15% w/v, citric acid cycle intermediates are present in an amount of between about 0% w/v and about 10% w/v, acetic acid is present in an amount between about 0% v/v and about 30% v/v, propylene glycol is present in an amount between about 0% v/v and 30% v/v; and seed oil is present in an amount between about 0% v/v and 30% v/v.

The present invention also considers A natural herbicide composition prepared by combining

a) about 3 to about 6 parts by volume solid urea;

b) about 3 to about 5 parts by volume water;

c) about 0.1 to about 2 parts by volume salt;

d) about 0.5 to about 2 parts by volume citric acid cycle intermediates; and

e) one or more components selected from the group consisting of

i) about 0.0125 to about 5 parts by volume 100% v/v acetic acid;

ii) about 0.25 to about 5 parts by volume propylene glycol;

iii) about 0.25 to about 5 parts by volume seed oil; and

iv) a mixture thereof,

with the proviso that either acetic acid or propylene glycol, but not both, is present in the mixture and wherein the final concentration of urea in the composition is at least 30% w/v

Also contemplated by the present invention is a natural herbicide composition wherein urea is present in an amount between about 50% (w/v) and about 62% (w/v), acetic acid in an amount between about 0.01% (v/v) and about 20% (v/v), citric acid cycle intermediates in an amount of between about 7% w/v to about 10% w/v, and salt in an amount of between 7% w/v and 12% w/v.

In a further aspect, the natural herbicide comprises urea in an amount of about 52% w/v, salt in an amount of about 11% w/v, citrate in an amount of about 8% w/v and acetic acid in an amount of about 0.25% v/v.

Also contemplated by the present invention is the natural herbicide composition as defined above comprising

a) about 5 parts by volume solid urea;

b) about 3 parts by volume water;

c) about 0.5 part by volume salt;

d) about 0.5 part by volume citric acid, and;

e) about 0.025 part by weight of 100% v/v acetic acid.

The present invention also provides a method of inhibiting the growth, development or both growth and development of one or more target weeds, the method comprising applying the natural herbicide composition, as defined above, to one or more target weeds.

Also contemplated by the present invention is a method of inhibiting weed growth on a plot of land comprising one or more plants and at least one species of weed, the method comprising applying the natural herbicide composition as defined above to the plants and the at least one species of weed on the plot of land. The natural herbicide composition may be applied to the leaves.

Further, the present invention contemplates a method of making a natural herbicide composition comprising:

a) providing an aqueous urea solution containing about 30% w/v to about 62% w/v;

b) combining one, or more than one, component selected from the group consisting of acetic acid, propylene glycol, seed oil and a mixture thereof to said urea solution to form said natural herbicide composition; and optionally

c) filtering the natural herbicide composition,

with the proviso that either acetic acid or propylene glycol, but not both, is present in the mixture and wherein the final concentration of urea in the composition is at least 30% w/v.

However, other methods of making the natural herbicide compositions may also be employed. For example, but not wishing to be limiting, the present invention further contemplates a method of making a natural herbicide composition comprising,

a) providing an aqueous urea solution containing about 30% w/v to about 62% w/v;

b) combining salts, citrate and one, or more than one, component selected from the group consisting of acetic acid, propylene glycol, seed oil and a mixture thereof to said urea solution to form said natural herbicide composition; and optionally

c) filtering the natural herbicide solution

with the proviso that either acetic acid or propylene glycol, but not both, is present in the mixture and wherein the final concentration of urea in the composition is at least 30% w/v.

Also contemplated is a method of making a natural herbicide composition comprising combining water, urea, and one, or more than one, component selected from the group consisting of acetic acid, propylene glycol, seed oil and a mixture thereof, and optionally adding salt and citric acid to form a natural herbicide solution, and optionally heating, agitating or both heating and agitating the natural herbicide solution to dissolve all components.

The present invention also contemplates the natural herbicide composition produced according to the methods as defined above.

This summary does not necessarily describe all necessary features of the invention but that the invention may also reside in a sub-combination of the described features.

### DESCRIPTION OF PREFERRED EMBODIMENT

The invention relates to herbicide compositions. More specifically the present invention relates to natural herbicide compositions.

The following description is of a preferred embodiment by way of example only and without limitation to the combination of features necessary for carrying the invention into effect.

According to the present invention, there is provided a natural herbicide composition comprising in its basic form urea, water and one or more of acetic acid and a binding agent. By the term “natural” it is meant that the herbicide composition comprises materials in amounts that are generally regarded as safe and considered non-toxic to humans, animals, and select vegetation, while being capable of controlling the growth, development or both, of at least one target weed species. The components of the natural herbicide composition are also preferably biodegradable.

By “binding agent”, it is meant one, or more than one compound, that enhances the effect of the natural herbicide composition of the present invention, on a plant. Without wishing to be bound by theory, the binding agent may increase contact time between the active ingredients of the composition and the plant or weed tissue. By maintaining the herbicide composition on a surface of a plant, uptake of the herbicide composition occurs over a longer period of time, when compared with the herbicide applied to the plant in the absence of the binding agent. Alternatively, the binding agent may enhance uptake of the herbicide composition within the plant. Non-limiting examples of a binding agent include emulsifiers, extenders, or both, for example, propylene glycol, seed oil, and a combination thereof.

A non-limiting example of the natural herbicide composition of the present invention comprises, urea, present in an amount of about 30% w/v to about 62% w/v, or an amount there between; and a compound selected from the group consisting of:

acetic acid in an amount of about 0% v/v to about 30% v/v, or an amount there between;

a binding agent in an amount of about 0% v/v to about 30% v/v, or an amount there between; and

a combination of b) and c).

If the natural herbicide composition as described herein is to be used in a liquid form, and the composition comprises both acetic acid and propylene glycol, then it is desired that the amount of acetic acid used in the composition is of a concentration that does not lead to gelling of the propylene glycol in the final composition. For example, which is not to be considered limiting in any manner, in a composition comprising propylene glycol as the binding agent, acetic acid may be present from about 0% v/v to about 5% v/v, or an amount there between. However, it is to be understood that if a gel, semi-solid, or solid formulation of the natural herbicide composition is to be prepared, then the amount of acetic acid within a composition comprising propylene glycol may be increased, for example, from about 0% v/v to about 30% v/v.

As an alternative, a composition of the present invention may comprise urea and one or more of acetic acid, propylene glycol, seed oil or a mixture thereof in an aqueous solution. For example, which is not to be considered limiting in any manner, the composition of the present invention may comprise, urea, present in an amount of about 30% w/v to about 62% w/v, or an amount there between, and one or more than one of:

a) acetic acid in an amount of about 0% v/v to about 30% v/v, or an amount there between;

b) propylene glycol in an amount of about 0% v/v to about 30% v/v, or an amount there between; and

c) seed oil in an amount of about 0% v/v to about 30% v/v, or an amount there between;

in an aqueous solution.

The seed oil employed by the present invention may include, but is not limited to, flax seed oil, canola oil, soya oil, sunflower oil, peanut oil, cottonseed oil, corn oil, denaturalized flax seed oil, denaturalized canola oil, denaturalized soya oil, denaturalized sunflower oil, denaturalized peanut oil, denaturalized cottonseed oil, denaturalized corn oil and mixtures thereof. A denaturalized oil is an oil that has been refined and de-gummed and to which an emulsifier can be added. A denaturalized oil may also comprise about 7% emulsifier.

In another aspect of the present invention, which is not to be considered limiting in any manner, the natural herbicide composition may comprise between about 50% w/v and about 62% w/v urea. In a further non-limiting aspect of the present invention, acetic acid may be present in the natural herbicide in an amount of between about 0.01% v/v and about 20% v/v. Concentrated acetic acid or food grade vinegar may be used as the source of acetic acid, as desired.

The present invention also provides a natural herbicide composition comprising:

a) about 60%w/v urea; and

b) about 0.14% v/v acetic acid,

in an aqueous solution.

As will be evident to someone of skill in the art, the final concentrations for the components in the compositions defined above are given as percent weight/volume (% w/v) for dry components and percent volume/volume (% v/v) for liquid components.

In an alternate aspect, which is not to be considered limiting in any manner the present invention provides a natural herbicide composition comprising:

a) about 3 to about 6 parts by volume solid urea, or an amount there between;

b) about 3 to about 5 parts by volume water, or an amount there between; and

c) one, or more than one, component selected from the group consisting of:

i) about 0.01 to about 5 parts by volume 100% v/v acetic acid, or an amount there between;

ii) about 0.25 to about 5 parts by volume propylene glycol, or an amount there between;

iii) about 0.25 to about 5 parts by volume seed oil, or an amount there between; and

iv) a mixture thereof,

with the proviso the final concentration of urea in the composition is at least 30% w/v. Furthermore, as indicated above, if acetic acid and propylene glycol are present in the composition, and if the composition is a liquid formulation, then the amount of acetic acid is from about 0% v/v to about 5% v/v is present in the mixture.

For example, the natural herbicide composition may comprises:

a) about 5 parts by volume urea;

b) about 4 parts by volume water; and

c) about 0.0125 parts by volume 100% v/v acetic acid.

By the term “part” it is meant each of a number of equal portions. For the purpose of the present invention, each part is an equal measure of volume.

The urea employed by the present invention may be pharmaceutical grade or cosmetic grade. The purity of urea may be greater than about 95%, for example greater than about 98% or greater than about 99%. However, lower grades of urea may also be used, depending on the final concentration of urea required in the herbicide composition. Furthermore, the vinegar or acetic acid employed by the present invention may be food grade and capable of being ingested by humans. The vinegar employed by the present invention may comprise about 5% acetic acid, but the content of acetic acid in the vinegar may vary from about 2% to about 20% acetic acid (v/v). Alternatively, concentrated acetic acid, up to 100%, may be used in the preparation of the herbicide compositions of the present invention.

The natural herbicide composition of the present invention may further comprise additional components, for example, but not limited to salts, and citric acid cycle (Krebs cycle) intermediates. For example, but not wishing to be limiting the natural herbicide composition may comprise:

a) urea in an amount of about 30% w/v to about 62% w/v, or an amount there between;

b) salt in an amount of about 0% w/v to about 15% w/v, or an amount there between;

c) a citric acid cycle intermediate in an amount of about 0% w/v to about 10% w/v, or an amount there between; and one, or more than one of the following compounds:

acetic acid in an amount of about 0% v/v to about 30% v/v, or an amount there between;

propylene glycol in an amount of about 0% v/v to about 30% v/v, or an amount there between; and

seed oil in an amount of about 0% v/v to about 30% v/v, or an amount there between,

in an aqueous solution. If acetic acid and propylene glycol are present in the composition, and if the composition is a liquid formulation, then the amount of acetic acid is from about 0% v/v to about 5% v/v is present in the mixture.

An alternate, non-limiting example of the natural herbicide of the present invention comprises:

a) from about 50% w/v to about 62% w/v urea, or an amount there between;

b) from about 0.01% v/v to about 20% v/v acetic acid, or an amount there between;

c) from about 7% w/v to about 10% w/v citric acid cycle intermediates, or an amount there between; and

d) from about 7% w/v to about 12% w/v salt, or an amount there between.

As noted above, the natural herbicide composition of the present invention may comprise one or more salts. Preferably, the salt is sea salt, sodium chloride, potassium chloride, or a mixture thereof. However, other salts or combinations of salts may be employed in the composition of the present invention, for example, but not limited to calcium chloride.

By the term “sea salt” it is meant the salts and other components that exist following evaporation of sea water. There are similarities among sea waters throughout the world. The analysis of sea water may be performed by a person of skill in the art, for example, but not limited to, as described in Sverdrup, Johnson and Fleming (1942, The Oceans pages 176 and 177, which is herein incorporated by reference). As disclosed in U.S. Pat. No. 5,074,901 liquor made from New York sea water was determined to exhibit similarity with other sea waters, and to have the following composition:

TABLE 1
Composition of Sea Water

| Component | ppm (mg/l) |
|---|---|
| nitrate | <1 |
| sodium | 2141.69 |
| aluminum | 0.21 |
| cadmium | <0.01 |
| chromium total | 0.02 |
| chromium hexavalent | <0.01 |
| copper | 0.31 |
| iron | 0.37 |
| nickel | 0.02 |
| lead | 0.05 |
| silver | 0.19 |
| zinc | <0.01 |
| manganese | 0.05 |
| chloride | 2373.2 |
| sulfate | 4.11 |
| fluoride | 0.26 |
| calcium | 6.45 |
| barium | 0.07 |
| magnesium | 1.69 |
| ammonia | 0.15 |

Thus, the present invention contemplates using sea salt, including but not limited to sea salt that comprises the composition recited in Table 1. Further, the present invention contemplates using sea salts with compositions that are different in any one or all of the components listed above. For example, but not wishing to be limiting, the sea salt employed by the present invention may vary by an order of magnitude for any one or all of the components listed. However, it is preferable that the sodium and chloride content vary by less than about 50% of the amount listed. Further, other constituents not listed in the above table may be present in sea salt, for example, but not limited to potassium.

The composition of the present invention may also comprise one or more citric acid cycle or intermediates, such as, but not limited to citrate, cis-aconitate, isocitrate, α-ketoglutarate, succinate, fumarate, malate, as well as pyruvate (a glycolysis end product) or a combination thereof. Preferably, the citric acid cycle intermediate is citrate.

In an aspect of the present invention that is not to be considered limiting, the natural herbicide composition may comprise:

a) about 3 to about 6 parts by volume urea, or an amount there between;

b) about 3 to about 5 parts by volume water, or an amount there between;

c) about 0.1 to about 2 part by volume salt (or an amount there between), for example, but not limited to sea salt, sodium chloride, potassium chloride, or a combination thereof;

d) about 0.5 to about 2 parts by volume citric acid intermediate (or an amount there between), for example but not limited to, citrate, or an amount there between; and

e) one or more than one component selected from the group consisting of

i) about 0.01 to about 2 parts by volume 100% v/v acetic acid, or an amount there between;

ii) about 0.25 to about 5 parts by volume propylene glycol, or an amount there between;

iii) about 0.25 to about 5 parts by volume seed oil, or an amount there between; and

iv) mixtures thereof,

with the proviso that the final concentration of urea in the composition is at least 30% w/v. If acetic acid and propylene glycol are present in the composition, and if the composition is a liquid formulation, then the amount of acetic acid is from about 0% v/v to about 5% v/v is present in the mixture.

An alternated non-limiting example of such a composition comprises:

a) about 5 parts by volume urea;

b) about 3 parts by volume water;

c) about 0.5 part by volume salt, for example, but not limited to sea salt, sodium chloride, potassium chloride, or a combination thereof;

d) about 0.5 part by volume vinegar (comprising, but not limited to 5% acetic acid); and

e) about 0.5 part by volume citrate.

The natural herbicide composition may be employed to inhibit the growth or development, or both, of broad leafed and other target weeds, for example, but not limited to dandelion, lambsquarters, pigweed, thistle, nimbleweed, speedwell, oxalis, smartweed, turfgrass, bermudagrass, barnyardgrass, quakegrass, creeping bentgrass, crabgrass, creeping fescue and others. Preferably, the natural herbicide composition is sprayed onto the leaves of target weeds. Further, the natural herbicide composition of the present invention is preferably applied to target weeds or vegetation comprising the target weed in the morning or late afternoon, rather than at the peak or hottest time of the day.

The natural herbicide composition of the present invention may be employed to treat existing weeds or may be employed to prevent weed growth. In the latter case, the natural herbicide may be employed as a pre-emergent herbicide.

The composition of the present invention may be employed as a broad leaf herbicide for control of weeds that grow from or around a variety of surfaces. For example, the composition may be sprayed on hard surfaces with openings exposed to dirt where weeds are present or where weeds may develop. Such surfaces include, but are not limited to, asphalt, concrete, interlocking bricks, roads and highways. Compositions for this application may be, for example but not limited to, a composition comprising:

a) 10 parts by volume urea,

b) 6 parts by volume water,

c) 1 part by volume salt,

d) 1 part by volume vinegar (5% v/v acetic acid), and

e) 1 part by volume citrate.

This composition may further comprise from about 0 to about 5 parts by volume or an amount there between, of a binding agent, for example, but not limited to propylene glycol, seed oil, or a mixture thereof.

Further, the composition of the present invention may be applied to lawns, golf course greens, fairways, or the like. An example of a composition may include, but is not limited to 5 parts by volume of urea, 4 parts by volume water, and 0.25 parts by volume vinegar (5% v/v acetic acid). This composition may comprise from about 0 to about 5 parts by volume or an amount there between, of a binding agent, for example, but not limited to propylene glycol, seed oil, or a mixture thereof.

The natural herbicide composition of the present invention may be applied to an area of vegetation or a surface in an amount sufficient to control weed growth, for example to reduce growth or development of the weed, or kill the weed. As will be evident to a person of skill in the art, preferably the natural herbicide composition is sprayed onto target weeds. However, the natural herbicide composition may be poured onto weeds or surfaces to be treated for weeds, or the composition may be selectively applied onto weeds as a local or spot treatment, as required. The natural herbicide composition may be applied as a single treatment or as multiple treatments, for example, but not limited to, application on consecutive days, or weeks.

Treatment of a lawn, or other area, to control weed growth involves applying the herbicide composition on the surface, for example using a hand (local dosing), mechanical sprayer (broadcast application), or a rub. For example, but not wishing to be limiting, the herbicide composition can be applied the leaves of the weed. Applying the composition results in control of weed growth when applied over a range of amounts applied per area, for example, but not limited to from about 1 L to about 10 L of the composition per 1000 square feet. Any persistent weeds can be re-treated using local spraying or re-spraying the lawn surface, as required. The natural herbicide composition can be reapplied on a regular basis to maintain control of weed growth.

The present invention contemplates compositions comprising the natural herbicide composition of the present invention in combination with other herbicides as known in the art, for example but not limited to, non-natural herbicides, for example but not limited to Roundup® or Paraquat®. Other herbicides known in the art may be employed in such compositions. In such a manner, the effective concentration required for one or more non-natural herbicides may be reduced leading to less pollution or toxicity to the environment.

The present invention also contemplates a method of making a natural herbicide composition as described herein. In an aspect of an embodiment the natural herbicide is prepared according to the following method, which is not intended to be limiting in any manner: a stock solution comprising 62% w/v urea in water is prepared—gentle heating (from about 60° C. to about 100° C.), agitation or both may be employed to aid in the dissolution of the urea; the solution is cooled, for example to about 40° C. to about 80° C.; and vinegar or acetic acid is added, followed by other components as needed.

The solution is cooled to room temperature, filtered through a nylon filter and stored in an appropriate container, which is preferably air tight. In embodiments wherein the herbicide composition comprises salts, citric acid cycle intermediates or one or more than one binding agents, or a combination thereof, these components may be optionally added after the urea and water solution has cooled to about or below 80° C. The composition is stable in this form indefinitely.

As will be evident to someone of skill in the art, the composition of the present invention may be prepared in other ways provided that the final solution is effective as a herbicide. For example, but not wishing to be limiting, the composition may be prepared by combining together all the components in any order so that the components are dissolved. Similarly, urea may be added to water, and vinegar or acetic acid added to arrive at the final concentrations of the compositions as described herein. The resulting solution may be heated, agitated, or both to enhance dissolution of the components. However, it is preferred that urea is not mixed with acetic acid directly, furthermore is it preferred that urea not be subjected to long periods at elevated temperatures, for example, but not limited to at temperatures at or near 100° C. for periods longer than about 1 hour.

The composition may be prepared using any method that ensures that the components of the composition remain soluble in the composition. Alternatively, a gel, semi-solid or solid form of the herbicide may be desired, and ingredients may be selected and combined in such a manner that the components of the composition remain in a suspension.

The present invention is also directed to a natural herbicide composition prepared according to any one or all of the methods as defined above.

The present invention also contemplates a method of controlling the growth, development or both the growth and development of a target weed, comprising applying an effective amount of the natural herbicide composition of the present invention to the leaves of the target weed. Further, the present invention contemplates a method of controlling the growth, development or both the growth and development of one or more weeds in an area of vegetation, comprising applying an effective amount of the natural herbicide composition to the area of vegetation. Preferably, the herbicide composition is applied in a manner such that the herbicide composition is delivered to the leaves of the one or more weeds. The present invention further contemplates similar methods wherein a non-natural herbicide is employed in combination with the natural herbicide composition of the present invention.

The above description is not intended to limit the claimed invention in any manner, Furthermore, the discussed combination of features might not be absolutely necessary for the inventive solution.

The present invention will be further illustrated in the following examples. However, it is to be understood that these examples are for illustrative purposed only, and should not be used to limit the scope of the present invention in any manner.

### EXAMPLES

### Example 1

### Natural Herbicide Compositions

TABLE 1
Natural Herbicide Composition 1.

| | | Parts as % of | Final |
|---|---|---|---|
| Component | Parts | composition | concentration |
| solid urea | 5 | 54.1 | ˜60% (w/v)* |
| Water | 4 | 43.2 | — |
| vinegar^{†} | 0.25 | 2.7 | 0.135% (v/v) |

*approximately 28% (w/v) nitrogen
^{†}5% (v/v) acetic acid

A solution of urea in water is prepared; this solution may be at or near the saturation point. The solution may be warmed and agitated. At this time, the vinegar is added and the solution is stirred. Following the addition of vinegar, the composition is cooled to room temperature and filtered through a nylon filter. The composition is sealed and stored in an airtight container.

A binding agent may be added to the natural herbicide composition 1 prior to storage or use, for example by adding from 0 to 1 part by volume binding agent, to 5 parts of the composition. The binding agent may be propylene glycol, a seed oil, or a mixture thereof.

Alternatively, 2.8 ml (0.25 parts) of vinegar may be added to 100 ml (9 parts) of a saturated urea solution. The composition is mixed, sealed and stored. Larger amounts of the composition may be prepared by scaling up the ingredients as needed.

TABLE 2
Natural Herbicide Composition 2.

| | | Parts as % of | |
|---|---|---|---|
| Component | Parts | composition | final concentration |
| urea | 10 | 52.6 | 52% (w/v)* |
| water | 6 | 31.5 | — |
| salt | 1 | 5.3 | 11% (w/v) |
| citrate | 1 | 5.3 | 8% (w/v) |
| vinegar^{†} | 1 | 5.3 | 0.25% (w/v) |

*approximately 24% (w/v) nitrogen
⁵⁵⁴ 5% (v/v) acetic acid

A solution of urea in water is prepared. The solution may be warmed and agitated. At this time the salt (a mixture of sea salt and NaCI), vinegar and citrate are added and the solution is stirred. Following the additions the composition is cooled to room temperature and filtered through a nylon filter. The resulting composition is sealed and stored in an air-tight container.

Alternatively, 5.26 g of a mixture of sea salt and NaCl, 5.26 g citric acid, and 0.263 g of a 5% vinegar solution is added to 100 mL of saturated urea solution. The composition is mixed, sealed and stored. Larger amounts of the composition may be prepared by scaling up the ingredients as needed.

A binding agent may be added to the natural herbicide composition 2 just defined, prior to storage or use, for example by adding from 0 to 1 part by volume binding agent, to 5 parts of the composition. The binding agent may be propylene glycol, a seed oil, or a mixture thereof.

TABLE 3
Natural Herbicide Composition 3.

| | | Parts as % of | Final |
|---|---|---|---|
| Component | Parts | composition | concentration |
| 50% w/v aqueous urea | 8.5 | 85 | ˜43% (w/v)* |
| solution | | | |
| propylene glycol | 1.5 | 15 | 15% (v/v) |

*approximately 19.8% (w/v) nitrogen

A solution of 50% w/v urea is obtained. The solution may be warmed and agitated. At this time, the propylene glycol is added and the solution is stirred. Following the addition of propylene glycol, the composition is cooled to room temperature and filtered through a nylon filter. The composition is sealed and stored in an airtight container.

Alternatively, 42.5 g of solid urea is combined with water to a final volume of 85 mL. To this solution, 15 mL of propylene glycol is added. The composition is mixed, sealed and stored. Larger amounts of the composition may be prepared by scaling up the ingredients as needed.

A binding agent may be added to the natural herbicide composition 3 just defined, prior to storage or use, for example by adding from 0 to 1 part by volume binding agent, to 5 parts of the composition. The binding agent may be propylene glycol, a seed oil, or a mixture thereof.

### Example 2

### Application of the Natural Herbicide Composition

Treatment of a lawn, or other area, to control weed growth involves spraying the composition as described above on the surface using a hand or mechanical sprayer. Treatment is carried out in the morning.

Applying the composition results in a rapid control of weed growth when applied over a range of amounts applied per area, for example, but not limited to from about 1 to about 10 L of the composition of example 1 per 1000 square feet. Any persistent weeds are re-treated using local spraying or re-spraying the lawn surface as required within a day or two, or a week of the initial treatment. The natural herbicide composition is reapplied on a regular basis to maintain control of weed growth.

Following this treatment, reduced weed growth, or death of weeds is observed.

All publications, patents, and patent documents, cited in this application, are herein incorporated by reference, as though individually incorporated by reference.

The present invention has been described with regard to preferred embodiments. However, it will be obvious to persons skilled in the art that a number of variations and modifications can be made without departing from the scope of the invention as described herein.

What is claimed is:

1. A natural herbicide composition comprising urea, water and a compound selected from the group consisting of acetic acid, a binding agent, and a combination thereof.

2. The natural herbicide composition of claim 1, wherein the urea is present in an amount between about 30% w/v and about 62% w/v.

3. The natural herbicide composition as defined in claim 2, wherein the binding agent is selected from the group consisting of:
acetic acid from an amount between about 0% v/v and about 30% v/v;
propylene glycol from an amount between about 0% v/v and 30% v/v;
seed oil from an amount between about 0% v/v and 30% v/v; and
a combination thereof.

4. The natural herbicide composition of claim 3, wherein the urea is present in an amount between about 40% w/v and about 62% w/v.

5. The natural herbicide composition of claim 4, wherein the natural herbicide composition comprises acetic acid, and the acetic acid is present in an amount between about 0.01% v/v and about 20% v/v.

6. The natural herbicide composition of claim 5, wherein the urea is present in an amount of about 60% w/v, and the acetic acid is present in an amount of about 0.14% v/v.

7. The natural herbicide composition of claim 4, wherein the urea is present in an amount of about 43% w/v, and the propylene glycol is present in an amount of about 15% v/v.

8. The natural herbicide composition according to claim 3, wherein the seed oil is selected from the group selected from flax seed oil, canola oil, soya oil, sunflower oil, peanut oil, cottonseed oil, corn oil, denaturalized flax seed oil, denaturalized canola oil, denaturalized soya oil, denaturalized sunflower oil, denaturalized peanut oil, denaturalized cottonseed oil, denaturalized corn oil and mixtures thereof.

9. A natural herbicide composition comprising
a) about 3 to about 6 parts by volume solid urea;
b) about 3 to about 5 parts by volume water, and;
c) one, or more than one, component selected from the group consisting of:
about 0.01 to about 5 parts by volume 100% v/v acetic acid;
about 0.25 to about 5 parts by volume propylene glycol;
about 0.25 to about 5 parts by volume seed oil; and
any combination thereof,
with the proviso that the final concentration of urea in the composition is at least 30% w/v.

10. The natural herbicide composition according to claim 9, wherein the seed oil is selected from the group selected from flax seed oil, canola oil, soya oil, sunflower oil, peanut oil, cottonseed oil, corn oil, denaturalized flax seed oil, denaturalized canola oil, denaturalized soya oil, denaturalized sunflower oil, denaturalized peanut oil, denaturalized cottonseed oil, denaturalized corn oil and mixtures thereof.

11. A natural herbicide composition prepared by combining:
a) about 3 to about 6 parts by volume solid urea;
b) about 3 to about 4 parts by volume water, and;
c) one, or more than one, component selected from the group consisting of:
about 0.01 to about 5 parts by volume 100% v/v acetic acid;
about 0.25 to about 5 parts by volume propylene glycol;
about 0.25 to about 5 parts by volume seed oil;
and a mixture thereof,
with the proviso that the final concentration of urea in the composition is at least 30% w/v.

12. The natural herbicide composition of claim 11 comprising,
a) about 5 parts by volume solid urea;
b) about 4 parts by volume water, and;
c) about 0.0125 parts by volume 100% v/v acetic acid.

13. The natural herbicide composition of claim 11 comprising,
a) about 8.5 parts by volume 50% w/v aqueous urea solution; and
b) about 1.5 parts by volume propylene glycol.

14. The natural herbicide composition of claim 3, further comprising one or more components selected from the group consisting of a salt, one or more than one citric acid cycle intermediate, and pyruvate.

15. The natural herbicide composition of claim 14, wherein the salt comprises sea salt, sodium chloride, potassium chloride, calcium chloride, or a combination thereof.

16. The natural herbicide composition of claim 15, wherein the salt comprises sea salt or sodium chloride.

17. The natural herbicide composition of claim 14, wherein the citric acid cycle intermediate is selected from the group consisting of citrate, cis-aconitate, isocitrate, α-ketoglutarate, succinate, fumarate, malate, or a combination thereof.

18. The natural herbicide composition of claim 17, wherein the citric acid cycle intermediate is citrate.

19. The natural herbicide composition of claim 14 wherein, the salt is present in an amount of between about 0% w/v and about 15% w/v, and the citric acid cycle intermediate is present in an amount of between about 0% w/v and about 10% w/v.

20. A natural herbicide composition comprising:
a) about 3 to about 6 parts by volume solid urea;
b) about 3 to about 5 parts by volume water;
c) about 0.1 to about 2 parts by volume salt;
d) about 0.5 to about 2 parts by volume citric acid cycle intermediates; and
e) one or more than one component selected from the group consisting of
about 0.0125 to about 5 parts by volume 100% v/v acetic acid;
about 0.25 to about 5 parts by volume propylene glycol;
about 0.25 to about 5 parts by volume seed oil; and
a mixture thereof,
with the proviso that the final concentration of urea in the composition is at least 30% w/v.

21. The natural herbicide composition to claim 20, wherein the seed oil is selected from the group selected from flax seed oil, canola oil, soya oil, sunflower oil, peanut oil, cottonseed oil, corn oil, denaturalized flax seed oil, denaturalized canola oil, denaturalized soya oil, denaturalized sunflower oil, denaturalized peanut oil, denaturalized cottonseed oil, denaturalized corn oil and mixtures thereof.

22. A natural herbicide composition prepared by combining:
a) about 3 to about 6 parts by volume solid urea;
b) about 3 to about 5 parts by volume water;
c) about 0.1 to about 2 parts by volume salt;
d) about 0.5 to about 2 parts by volume citric acid cycle intermediates; and
e) one or more than one component selected from the group consisting of:
about 0.0125 to about 5 parts by volume 100% v/v acetic acid;
about 0.25 to about 5 parts by volume propylene glycol;
about 0.25 to about 5 parts by volume seed oil; and
a mixture thereof,
with the proviso that the final concentration of urea in the composition is at least 30% w/v.

23. The natural herbicide composition according to claim 22, wherein the seed oil is selected from the group selected from flax seed oil, canola oil, soya oil, sunflower oil, peanut oil, cottonseed oil, corn oil, denaturalized flax seed oil, denaturalized canola oil, denaturalized soya oil, denaturalized sunflower oil, denaturalized peanut oil, denaturalized cottonseed oil, denaturalized corn oil and mixtures thereof.

24. The natural herbicide of claim 5, further comprising between about 7% w/v to about 10% w/v of one, or more than one, citric acid cycle intermediate, and between about 7% w/v and 12% w/v salt.

25. The natural herbicide of claim 20, wherein the urea is present in an amount of about 52% w/v, the salt is present in an amount of about 11% w/v, the citric acid cycle intermediates is citrate and is present in an amount of about 8% w/v and the acetic acid is present in an amount of about 0.25% v/v.

26. The natural herbicide of claim 17, wherein the composition comprises
a) about 5 parts by volume solid urea;
b) about 3 parts by volume water;
c) about 0.5 part by volume salt;
d) about 0.5 part by volume citrate, and;
e) about 0.025 part by volume 100% v/v acetic acid.

27. A method of inhibiting the growth, development or both growth and development, of one or more than one weed, the method comprising applying the composition of claim 1 to the one or more than one weed.

28. A method of inhibiting the growth, development or both growth and development, of one or more than one weed, the method comprising applying the composition of claim 14 to the one or more than one weed.

29. A method of inhibiting weed growth on a plot of land comprising one or more than one plant and one or more than one species of weed, the method comprising applying the composition of claim 1 to the one or more than one plant and the one or more than one species of weeds, on the plot of land.

30. A method of inhibiting weed growth on a plot of land comprising one or more than one plant and one or more than one species of weed, the method comprising applying the composition of claim 13 to the one or more than one plant and the one or more than one species of weeds, on the plot of land.

31. A method of making a natural herbicide composition comprising:
a) providing an aqueous urea solution containing about 30% w/v to about 62% w/v urea; and
b) combining one, or more than one, component selected from the group consisting of acetic acid, propylene glycol, seed oil and a mixture thereof to the urea solution to form the natural herbicide composition.

32. A method according to claim 31, wherein the seed oil is selected from the group selected from flax seed oil, canola oil, soya oil, sunflower oil, peanut oil, cottonseed oil, corn oil, denaturalized flax seed oil, denaturalized canola oil, denaturalized soya oil, denaturalized sunflower oil, denaturalized peanut oil, denaturalized cottonseed oil, denaturalized corn oil and mixtures thereof.

33. The method of claim 31, wherein after the step of combining, the natural herbicide composition is filtered.

34. A natural herbicide composition produced according to the method of claim 31.

35. The method of claim 31, wherein in the step of combining, a salt and citrate are added along with said one, or more than one, component to form the natural herbicide solution.

36. The method of claim 35, wherein after said step of combining, the natural herbicide composition is filtered.

37. A natural herbicide composition produced according to the method of claim 35.

38. A method of making a natural herbicide composition comprising:
a) combining water, urea, and one, or more than one, component chosen from the group consisting of acetic acid, propylene glycol, seed oil and a mixture thereof;
b) adding salt and citric acid, to form a solution, and;
c) heating and agitating the solution.

39. A natural herbicide composition produced according to the method of claim 38.
